(19) United States
(12) Patent Application Publication
(10) Pub. No.: US 2006/0155030 A1
(43) Pub. Date: Jul. 13, 2006

(54) Exfoliate structured zirconium phosphate, precursors of said phosphate, method for the production and use thereof in macromolecular-material-based compositions

(76) Inventors: Nicole Aupaix, Plaisir (FR); Dominique Dupus, Crepy-En-Valois (FR)

Correspondence Address: RHODIA INC., 259 PROSPECT PLAINS ROAD, CN 7500, CRANBURY, NJ, 08512, US

(21) Appl. No.: 10/539,871

(22) PCT Filed: Dec. 17, 2003
(86) PCT No.: PCT/FR03/03779

§ 371 Date: Nov. 23, 2005

(30) Foreign Application Priority Data
Dec. 20, 2002 (FR) 02/16310

(51) Int. Cl. C08K 3/22

(52) U.S. Cl. 524/413

(57) ABSTRACT

The invention relates to an exfoliate structured zirconium phosphate characterized in that it is embodied in the form of a gel containing a maximum 1000 ppm organic compounds or a gel devoid of organic compounds which are chemically linked to phosphate. Said phosphate is obtained by a method wherein an aqueous dispersion is formed from a crystallized zirconium phosphate; a quantity of sodium compound is added to said dispersion whereby the NA/P ratio is more than 0.5; an acid is added in order to obtain a gel or a solid compound which is placed once more in water and which results in a gel; the phosphate can be used in the preparation of macromolecular-material-based compositions in order to improve the properties thereof.

The present invention relates to a zirconium phosphate with an exfoliated structure which is provided in the form of a gel, to precursors of this phosphate, to its preparation process and to its use in compositions based on macromolecular materials.

The use of inorganic particles to modify the thermo-mechanical properties of macromolecular materials is known. It is thus possible to modify, for example, the modulus of the materials, the impact strength, the ductility, the dimensional stability, the heat deflection temperature, the resistance to abrasion or the abrasiveness. In some cases, such as latexes, the aim is also to improve the characteristics of water uptake and of permeability to water vapor of the materials.

It is known to reinforce macromolecular materials and in particular thermoplastics with platelet particles of nanometric thickness. Such particles can, for example, be obtained by exfoliation from an inorganic compound with a lamellar structure. This is the case, for example, for the particles obtained from montmorillonite. For this, montmorillonite, which exhibits a lamellar structure, is treated with an organic expanding agent which inserts itself between the lamellae and moves them away from one another, in order to promote their exfoliation. The organic agent often comprises an ammonium group and at least one relatively long chain. The preferred ammoniums are quaternary ammoniums.

The use is also known of platelet particles obtained by exfoliation from a compound based on zirconium phosphate with a lamellar structure. The compound with a lamellar structure is treated with an organic expanding agent before incorporation in a material to be reinforced, in order to provide for its exfoliation, which exfoliation is important for improving the thermomechanical properties of the material into which it is introduced.

However, there are disadvantages to the use of organic expanding agents. This is because the latter can damage the quality of the macromolecular materials in which they are used. They can result in difficulties during the incorporation of the particles or during the forming of the materials. Finally, these agents are generally malodorous, which makes it unpleasant to handle them or requires large capital expenditures if freedom from the smell is to be obtained.

The object of the invention is to provide exfoliated compounds which do not comprise organic products in order to eliminate the disadvantages mentioned above.

With this aim, the invention relates, according to a first embodiment, to a zirconium phosphate with an exfoliated structure which is characterized in that it is provided in the form of a gel, the content of organic compounds of which is at most 1000 ppm.

The invention also applies, according to a second embodiment, to a zirconium phosphate with an exfoliated structure which is characterized in that it is provided in the form of a gel devoid of organic compounds chemically bonded to the phosphate.

The invention also relates, as precursor of the preceding product, to a sodium zirconium phosphate which is characterized in that it exhibits a Na/P ratio of greater than 0.5, more particularly of at least 0.7 and more particularly still at least equal to 0.8.

The invention also relates, also as precursor, to a zirconium phosphate, characterized in that it exhibits, by solid-state NMR analysis, shifts at −19 ppm and at least one other shift between −20 ppm and −23 ppm and an X-ray diffraction diagram with peaks at 10.66, 5.32 and 7.65.

The invention also relates to a process for the preparation of the abovementioned zirconium phosphate with an exfoliated structure which is characterized in that it comprises the following stages:
(a) an aqueous dispersion of a crystalline zirconium phosphate is formed;
(b) a sodium compound is added to said dispersion in an amount such that the Na/P ratio is greater than 0.5, more particularly is at least 0.7 and more particularly still is at least equal to 0.8;
(c) an acid is subsequently added, whereby either a gel or a solid compound is obtained, which solid compound is put back into water and gives a gel.

Finally, the invention relates to the use of the zirconium phosphate described above in the preparation of compositions based on macromolecular materials.

In addition to the fact that it does not comprise organic products, the zirconium phosphate of the invention exhibits the advantage of improving the characteristics of water uptake and of permeability to water vapor of materials of the latex type in particular.

Other characteristics, details and advantages of the invention will become even more fully apparent on reading the description which will follow and the various concrete but nonlimiting examples intended to illustrate it.

The product of the invention is a zirconium phosphate which corresponds more particularly to the chemical formula Zr(HPO₄)₂. It should be noted that some hydrogen atoms can be substituted by sodium atoms. It should also be noted that the zirconium phosphate of the invention can comprise hafnium in an amount by weight which can be of the order of 1 to 2% by weight with respect to the zirconium phosphate. This hafnium generally originates from the starting materials used for the zirconium compounds employed in the process for the preparation of the phosphate of the invention. Finally, this phosphate may be hydrated.

The zirconium can be partially substituted by another tetravalent element, such as titanium, cerium and tin, for example in a proportion which can range up to 0.2 mol % (substituent/zirconium molar ratio). This possibility of substitution also applies to the precursors which will be described later.

The zirconium phosphate of the invention is composed of particles with a length of approximately 100 nm to 5 μm, more particularly of 200 nm to 2 μm, and with a thickness of approximately 0.7 nm to 1 nm. The form factor of these particles (length/thickness ratio) is at least approximately 100, more particularly 142, preferably at least 500, and it is preferably at most 5000, more particularly at most 2000.

The zirconium phosphate of the invention exhibits an exfoliated structure. This is understood to mean that the particles are set out as sheets which can either exhibit an intersheet distance of several tens of angstroms, for example of the order of 50 to 100 angstroms, or can be distributed in a disorganized way. The exfoliated structure can be demonstrated either by X-ray analysis, the X-ray diagrams revealing an amorphous structure, or by cryogenic TEM.

The zirconium phosphate of the invention exhibits a high specific surface which also reflects the exfoliated nature of its structure. Thus, this specific surface can be at least 200 m²/g, more particularly at least 300 m²/g and more particularly still at least 400 m²/g. Values of 500 m²/g to 600 m²/g can be obtained. These specific surface values are obtained by the small angle X-ray scattering technique.

The zirconium phosphate of the invention is provided in the form of a gel which can more particularly be an aqueous gel. The water content of the gel is usually at least 95% (by weight) and it can, for example, be between 97% and 98%.

Furthermore, as indicated above, the phosphate of the invention can be provided according to two embodiments.

In the case of the first embodiment, the phosphate, in the gel form, is characterized by its purity with regard to organic compounds. Thus, it exhibits a content of organic compounds which is at most 1000 ppm, more particularly at most 500 ppm. This content can even more particularly be at most 300 ppm. The term “organic compounds” is understood to mean any compound comprising carbon and in particular any compound of the expanding agent type mentioned above.

The content mentioned above is expressed as weight of carbon with respect to the zirconium phosphate in the dry state. This content is determined by an analysis which consists in oxidizing the product in the presence of a catalyst in an induction oven while flushing with oxygen. The carbon is detected by detection and then integration of the CO₂ peak (infrared quantitative determination). This analysis can be carried out with a device from Leco with the reference CS-044. In this case, the catalyst used can be Lecocel from Leco, ref. 763-266-PL, added to the standards and to the samples to be analyzed (approximately 3 g), or the product, ref. 502-231 (high purity iron chip accelerator), from the same company (approximately 1.2 g per measurement), added to the samples.

In the case of a second embodiment, the phosphate of the invention has, as essential characteristic, the fact of being devoid of organic compounds chemically bonded to the phosphate. The term “devoid of organic compounds chemically bonded to the phosphate” is understood to mean, for this second embodiment, that the phosphate does not comprise organic compounds which might be present between the sheets of particles and which might be bonded via a chemical bond to the zirconium phosphate, in particular by deprotonation of the PO₄ functional group and protonation of the organic compound, for example a bond of the PO₄⁻ . . . H₃⁺N— type in the case of an organic compound of amine type. For this second embodiment, the phosphate can optionally comprise organic compounds of another type from that defined above, that is to say not bonded to the phosphate. This can thus be carbon originating from the starting materials used in the manufacture of the zirconium phosphate. The absence of organic compounds chemically bonded to the phosphate can be demonstrated by NMR or infrared analyses.

For the second embodiment, the phosphate can, according to a specific alternative form and as for the first embodiment, also exhibit a content of organic compounds of at most 1000 ppm, more particularly of at most 500 ppm and more particularly still of at most 300 ppm.

The pH of the gel of the invention can vary within a wide range depending on the embodiments. More particularly, this pH can be at most 4, for example between 3 and 4, or else at most 2. These pH values are given for specific embodiments but it is clear that higher pH values can be entirely envisaged.

The gel can also exhibit an electrical conductivity, measured with a conductivity meter, of at most 5 mS.

The gel of the invention exhibits the advantage of being relatively insensitive to the pH; specifically, the latter can vary with a certain range without having an effect on the stability (absence of flocculation) and the viscosity of the gel.

As another characteristic, the zirconium phosphate of the invention exhibits, by solid-state NMR analysis, shifts at −19 ppm and at least one other shift of between −20 ppm and −23 ppm. These shifts are characteristic of a different protonation in comparison with a known crystalline zirconium phosphate.

The invention also applies to a phosphate which can be provided in the form of an organic gel, more specifically a gel in an organic compound or solvent. This organic solvent can be chosen in particular from water-soluble or water-miscible solvents. A solvent of this type can be chosen from alcohols, such as methanol or ethanol, glycols, such as ethylene glycol, glycol acetate derivatives, such as ethylene glycol mono-acetate, glycol ethers, polyols or ketones. Mention may be made, as other types of solvents, of divinylbenzene, styrene, toluene or acrylates. This phosphate, as an organic gel, is obtained from the phosphate described above.

According to another specific embodiment, the invention also relates to a zirconium phosphate with an exfoliated structure which comprises an intercalation compound between its constituent sheets of particles and which can be obtained from the phosphate which was described above. This product comprising such an intercalation compound is a crystalline product.

These intercalation compounds can be highly varied in nature. They can be, for example, cationic polymerization initiators, such as 2,2′-azobis(2-amidinopropane) hydrochloride, or else polymers, such as polyethyleneimine or polyethylene glycol, or amino acids, more particularly those with a chain length of C₆ to C₁₂. Mention may also be made, as intercalation compound, of triazine. These compounds can also be inorganic products, for example trivalent cations, such as aluminum.

According to another embodiment of the invention, the phosphate additionally comprises an oxide chosen from silica, alumina or titanium oxide. This oxide is generally present at the surface of the particles of the phosphate, which thus makes it possible to modify the surface chemistry of the particles. The oxide/Zr ratio by weight can range up to 500%, for example.

As was indicated above, the invention also relates to a specific sodium zirconium phosphate. It is characterized in that it exhibits a Na/P atomic ratio of greater than 0.5, more particularly of at least 0.7 and more particularly still at least equal to 0.8. This sodium zirconium phosphate is composed of particles with a size of approximately 100 nm to 5 μm in length, more particularly of 200 nm to 2 μm, and with a thickness of approximately 50 nm to 200 nm. The form factor of these particles (length/thickness ratio) is generally at most 30. These particles are set out as sheets exhibiting an intersheet distance of less than 15 angstroms, for example of approximately 10 to 12 angstroms. It may be supposed that the sodium atoms are positioned in this intersheet space.

This sodium zirconium phosphate is generally provided in the form of an aqueous dispersion. The pH of this dispersion is at least 7, preferably at least 9.

Another characteristic of this sodium zirconium phosphate is that it may be regarded as a precursor of the zirconium phosphate of the invention. In other words, this sodium zirconium phosphate can result in the zirconium phosphate with an exfoliated structure and in the gel form described above. This property is due to the fact that the sheets composed of the particles of this precursor are cleavable, that is to say that they exhibit a degree of freedom with respect to one another. This conversion of the precursor to a product with an exfoliated structure is carried out by acidification of the sodium zirconium phosphate.

The invention also relates to another or second precursor. It is a zirconium phosphate which is generally provided in the solid form, for example in the form of a powder. It has characteristics which distinguish it from the known crystalline zirconium phosphate of formula Zr(HPO₄)₂.1H₂O.

This is because, and as indicated above, this novel zirconium phosphate is characterized in that it exhibits, by NMR analysis (powder ³¹P solid-state NMR analysis), shifts at −19 ppm and at least one other shift of between −20 ppm and −23 ppm. The above known crystalline zirconium phosphate for its part only exhibits one shift at −19 ppm. The additional shifts of the phosphate of the invention are characteristic of a different protonation in comparison with this same known crystalline zirconium phosphate.

Furthermore, the X-ray diffraction diagram of the novel precursor zirconium phosphate demonstrates peaks at 10.66 and 5.32 which can be assigned to a product of formula Zr(HPO₄)₂.8H₂O and a peak at 7.65 which can be assigned to α-zirconium phosphate.

This novel zirconium phosphate can also be regarded as a precursor of the zirconium phosphate of the invention. It also exhibits the same properties as the first precursor described above. Specifically, it can result in a gel according to the invention. In this case, the conversion of this second precursor to a product with an exfoliated structure is carried out by diluting or resuspending said precursor in water.

Finally, this second precursor exhibits the advantageous property of being able to be used itself for the reinforcing of macromolecular materials. This is because it can be incorporated, preferably in the form of a suspension, in a material of this type, or during the preparation of the latter, and exfoliated during this incorporation or during this preparation. A material with improved properties is thus obtained. In addition, it should be noted that this second precursor can be used in large amounts in the material without, however, reducing the transparency of the latter.

The processes for the preparation of the products of the invention will now be described.

As indicated above, the process for the preparation of the zirconium phosphate with an exfoliated structure comprises a first stage (a) in which an aqueous dispersion of a crystalline zirconium phosphate is formed; a second stage (b) where a sodium compound is added to said dispersion in an amount such that the Na/P ratio is greater than 0.5, more particularly at least 0.7 and more particularly still at least equal to 0.8; and a final stage (c) in which an acid is subsequently added until a gel is obtained.

Any crystalline zirconium phosphate can be used as starting material in forming the dispersion of stage (a).

Such a crystalline phosphate can be prepared by a process in which a zirconium phosphate is first of all precipitated in an acidic medium from phosphoric acid and a zirconium compound, the zirconium being in the IV oxidation state.

Mention may be made, as zirconium-based starting compounds which can be used, of zirconium tetrahalides or zirconium oxyhalides, in particular zirconium oxychloride.

A simplified balance of the precipitation reaction is, for example, as follows:
2H₃PO₄+ZrOCl₂→Zr(H⁺,PO₄³⁻)₂+2HCl

Precipitation is preferably carried out in an aqueous medium. The use of phosphoric acid renders the precipitation medium acidic. The precipitation can advantageously be carried out at an acidic pH, preferably a controlled acidic pH, for example of between 0.5 and 2. To this end, use may be made, in addition to the precursors of the precipitate, of an acid. Hydrochloric acid is mentioned by way of example.

The precipitate can crystallize in a lamellar structure, at ambient temperature, without it being necessary to carry out a crystallization operation separate from the precipitation stage.

However, it can be advantageous to carry out a separate crystallization stage. Such a stage makes it possible to obtain, for the precipitated compound, a more marked and/or more uniform lamellar structure. Crystallization can be carried out by heat treatment of the product obtained above. It can be a treatment under warm conditions in water or in an aqueous solution, for example by immersion of the compound in water at a temperature of between 100° C. and 200° C. Crystallization is preferably carried out from an acidic aqueous solution, for example a phosphoric acid solution. The crystallization time can be several hours.

The crystallization stage can advantageously be preceded by a step of washing the precipitate, making it possible, inter alia, to remove the ionic entities resulting from the precipitation reaction.

The crystallization stage is advantageously followed by a stage of washing and centrifuging.

According to a preferred alternative form, the lamellar compound is never dried, the only operations for removing water being filtration or centrifuging operations. The term “drying operation” is understood here to mean an operation during which the compound is introduced into a hot atmosphere devoid of water for a period of time of greater than 15 minutes, for example into an oven.

As mentioned above, the first stage of the process for the preparation of the phosphate of the invention consists in forming an aqueous dispersion of the starting crystalline phosphate. This dispersion can exhibit a concentration of phosphate of the order of 20% by weight on a dry basis, for example. Its pH can be between 0.5 and 3, depending on the conditions for the preparation of the starting crystalline phosphate.

The second stage of the process consists in adding a sodium compound to the dispersion. This compound can be more particularly sodium hydroxide.

The role of the sodium compound is to make possible substitution of the protons H⁺ present in the crystalline phosphate by the Na⁺ cations. The degree of substitution must be such that the Na⁺ cation (contributed by the sodium compound)/P atomic ratio is greater than 0.5, preferably at least equal to 0.7 and more preferably still at least 0.8.

The addition of the sodium compound in the amounts given above has the effect of modifying the pH of the dispersion up to a value which is generally of at least 7, more particularly of at least 8 and more particularly still of at least 9.

On conclusion of this stage (b), the sodium zirconium phosphate precursor of the zirconium phosphate with an exfoliated structure of the invention is obtained. This precursor is thus provided here in the form of an aqueous dispersion. This dispersion can optionally be diluted or it can be dried to produce the precursor in the solid form. The precursor in the solid form can be resuspended in water to produce, in a subsequent stage, a phosphate with an exfoliated structure of the invention.

In order to obtain the latter phosphate, the process described above with stages (a) and (b) comprises a following stage, stage (c), which consists in introducing an acid into the medium obtained on conclusion of the preceding stage (b). Of course, as indicated above, it is possible to proceed as in the preceding stage, that is to say not on a medium resulting directly from stage (b) but on a medium obtained after resuspending in water the precursor isolated beforehand in the solid form.

The acid is generally an inorganic acid which can be chosen from hydrochloric acid, sulfuric acid, nitric acid and phosphoric acid.

The addition of the acid can result either directly in a gel, which is the product according to the invention, or in a solid compound which is obtained in suspension in the reaction medium. In the latter case, this compound is separated from the reaction medium and then put back into water. After this compound has been put back into water, the formation of a gel, which corresponds to the zirconium phosphate according to the invention, is observed.

The manner in which stage (c) can take place, that is to say direct access to the gel or passing through a solid compound, can depend on the nature of the acid used. It can also depend on the concentration of sodium zirconium phosphate in the dispersion used at the beginning of stage (c). By way of example, below a concentration of approximately 10 g/l, it is possible to obtain the gel directly. Thus, the implementation of stage (c) with hydrochloric acid and starting from a dilute dispersion can result directly in the gel.

The addition of the acid is generally carried out so as to bring the pH of the medium down to a value of at most 3, more particularly to a pH of approximately 2 or of at most 2.

The gel can be washed by centrifuging the latter and then redispersing the product obtained. This operation can be repeated several times. On conclusion of this washing operation, a gel is obtained which, depending on the number of washing operations carried out, can exhibit a pH of at most 4, for example of between 3 and 4.

It has been seen above that the invention also relates to a specific zirconium phosphate (second precursor) The process for the preparation of this second precursor is as follows.

This process first of all comprises stages (a) and (b) mentioned above. That which was described above concerning these two stages also applies here. Stage (c) is subsequently carried out using an acid as described above but which can more particularly be hydrochloric acid or phosphoric acid. The number of shifts between −20 ppm and −23 ppm demonstrated by NMR depends on the nature of the acid used. This stage (c) is carried out on a dispersion as obtained on conclusion of stage (b), this dispersion having to have a sufficiently high concentration of sodium zirconium phosphate to result, during stage (c), in a solid compound. This compound is subsequently separated from the reaction medium.

More particularly, in the case of phosphoric acid, the latter can be added to the dispersion resulting from stage (b) so as to lower the pH down to a value of at most 1.5.

In the case of the specific embodiment of the invention of a zirconium phosphate additionally comprising an oxide chosen from silica, alumina or titanium oxide, the preparation process is characterized in that a zirconium phosphate according to the invention, as described above, and a precursor of said oxide are brought into contact and then the oxide is precipitated.

In this case, the starting material is the phosphate of the invention in the gel form which is diluted so as to obtain a sufficiently fluid and suitably dispersed dispersion, in order to promote the homogeneous deposition of the oxide on the phosphate particles.

In the case of silica, it is possible to envisage precipitation of the silica by hydrolysis of an alkyl silicate, a reaction medium being formed by mixing water, alcohol, the phosphate and optionally a base, and the alkyl silicate subsequently being introduced, or alternatively preparation by reaction of the phosphate, of a silicate, of the alkali metal silicate type, and of an acid.

In the case of alumina, it is possible to react the phosphate, an aluminate and an acid, whereby alumina is precipitated. This precipitation can also be obtained by bringing together and reacting the phosphate, an aluminum salt and a base.

Finally, the alumina can be formed by hydrolysis of an aluminum alkoxide.

In the case of titanium oxide, it can be precipitated by introducing, into an aqueous suspension of the phosphate, a titanium salt, on the one hand, such as TiCl₄, TiOCl₂ or TiOSO₄, and a base, on the other hand. It is also possible to operate, for example, by hydrolysis or thermal hydrolysis of an alkyl titanate or precipitation of a titanium sol.

For the preparation of a phosphate according to another embodiment of the invention for which the phosphate is provided in the form of a gel in an organic solvent, it is possible to proceed by mixing the zirconium phosphate with an exfoliated structure in the form of an aqueous gel with said organic solvent. It can be advantageous to add a transfer agent to the organic solvent, the role of which is to accelerate the transfer of the phosphate particles from the aqueous medium to the organic medium. Such agents are known; they can, for example, be compounds with an alcohol functional group or carboxylic acids. In a second step, the mixture obtained is heated in order to remove the water.

To prepare the zirconium phosphate comprising an intercalation compound, it is possible to start from the aqueous gel obtained after washing and to mix this gel with the intercalation compound, in particular in the case of a compound of organic type, or with a precursor of the latter. A salt, such as a sulfate, can be used as precursor.

The zirconium phosphate with an exfoliated structure, as well as the zirconium phosphate corresponding to the second precursor, can be used in the preparation of compositions based on macromolecular materials. The invention thus also relates to a process for the preparation of such compositions in which zirconium phosphates according to the invention are used during the preparation of these compositions.

The macromolecular material can be of different natures: elastomeric, thermoplastic or thermosetting.

The macromolecular material can more particularly be a thermoplastic polymer. Mention may be made, as examples of polymers which may be suitable, of: polylactones, such as poly(pivalolactone), poly(caprolactone) and polymers of the same family; polyurethanes obtained by reaction between diisocyanates, such as 1,5-naphthalene diisocyanate, p-phenylene diisocyanate, m-phenylene diisocyanate, 2,4-toluene diisocyanate, 4,4′-diphenylmethane diisocyanate, 3,3′-dimethyl-4,4′-diphenylmethane diisocyanate, 3,3′-dimethyl-4,4′-biphenyl diisocyanate, 4,4′-diphenylisopropylidene diisocyanate, 3,3′-dimethyl-4,4′-diphenyl diisocyanate, 3,3′-dimethyl-4,4′-diphenylmethane diisocyanate, 3,3′-dimethoxy-4,4′-biphenyl diisocyanate, dianisidine diisocyanate, toluidine diisocyanate, hexamethylene diisocyanate, 4,4′-diisocyanatodiphenylmethane and compounds of the same family, and diols with long linear chains, such as poly(tetramethylene adipate), poly(ethylene adipate), poly(1,4-butylene adipate), poly(ethylene succinate), poly(2,3-butylene succinate), polyether diols and compounds of the same family; polycarbonates, such as poly[methanebis(4-phenyl)carbonate], poly[1,1-etherbis(4-phenyl)carbonate], poly[diphenylmethanebis(4-phenyl)carbonate], poly[1,1-cyclohexane-bis(4-phenyl)carbonate] and polymers of the same family; polysulfones; polyethers; polyketones; polyamides, such as poly(4-aminobutyric acid), poly(hexamethylene adipamide), poly(6-aminohexanoic acid), poly(m-xylylene adipamide), poly(p-xylylene sebacamide), poly(2,2,2-trimethylhexamethylene terephthalamide), poly(meta-phenylene isophthalamide), poly(p-phenylene terephthalamide), poly(12-aminododecanoic acid), poly(11-aminoundecanoic acid) and (co)polymers of the same family; polyesters, such as poly(ethylene azelate), poly(ethylene 1,5-naphthalate), poly(1,4-cyclohexane-dimethylene terephthalate), poly(ethylene oxybenzoate), poly(para-hydroxybenzoate), poly(1,4-cyclohexylidene-dimethylene terephthalate), polyethylene terephthalate, polybutylene terephthalate and polymers of the same family; poly(arylene oxides), such as poly(2,6-dimethyl-1,4-phenylene oxide), poly(2,6-diphenyl-1,4-phenylene oxide) and polymers of the same family; poly(arylene sulfides), such as poly(phenylene sulfide) and polymers of the same family; polyetherimides; vinyl polymers and their copolymers, such as polyvinyl acetate, polyvinyl alcohol, polyvinyl chloride, polyvinylbutyral, polyvinylidene chloride, ethylene-vinyl acetate copolymers and polymers of the same family; acrylic polymers, polyacrylates and their copolymers, such as polyethyl acrylate, poly(n-butyl acrylate), polymethyl methacrylate, polyethyl methacrylate, poly(n-butyl methacrylate), poly(n-propyl methacrylate), polyacrylamide, polyacrylonitrile, poly(acrylic acid), ethylene-acrylic acid copolymers, ethylene-vinyl alcohol copolymers, acrylonitrile copolymers, methyl methacrylate-styrene copolymers, ethylene-ethyl acrylate copolymers, methacrylate-butadiene-styrene copolymers, ABS and polymers of the same family; polyolefins, such as low density poly(ethylene), poly(propylene), low density chlorinated poly-(ethylene), poly(4-methyl-1-pentene), poly(ethylene), poly(styrene) and polymers of the same family; ionomers; poly(epichlorohydrins); poly(urethane)s, such as polymerization products of diols, such as glycerol, trimethylolpropane, 1,2,6-hexanetriol, sorbitol, pentaerythritol, polyetherpolyols, polyesterpolyols and compounds of the same family, with polyisocyanates, such as 2,4-tolylene diisocyanate, 2,6-tolylene diisocyanate, 4,4′-diphenylmethane diisocyanate, 1,6-hexamethylene diisocyanate, 4,4′-dicyclohexylmethane diisocyanate and compounds of the same family; polysulfones, such as the products of reaction between a sodium salt of 2,2-bis(4-hydroxyphenyl)propane and 4,4′-dichlorodiphenyl sulfone; furan resins, such as poly(furan); cellulose ester plastics, such as cellulose acetate, cellulose acetate butyrate, cellulose propionate and polymers of the same family; silicones, such as poly(dimethylsiloxane), poly(dimethylsiloxane-co-phenylmethylsiloxane) and polymers of the same family; or blends of at least two of the above polymers.

Preference is very particularly given, among these thermoplastic polymers, to polyamides, such as polyamide-6, polyamide-6,6, polyamide-12, polyamide-11, semiaromatic polyamides, PVC, PET, PPO and the blends and the copolymers based on these polymers.

Any method which makes it possible to obtain a dispersion of compounds in a macromolecular material can be employed to use the phosphates of the invention. A first process consists in blending a phosphate in a thermoplastic material in the melt form and in optionally subjecting the blend to high shearing, for example in a twin-screw extrusion device, in order to achieve good dispersion. Another process consists in mixing a phosphate to be dispersed with the monomers in the polymerization medium and then in carrying out the polymerization. Another process consists in blending, with a thermoplastic polymer in the melt form, a concentrated blend of a thermoplastic polymer and of a phosphate.

There is no restriction on the form under which the phosphate is introduced into the medium for the synthesis of the macromolecular material or into the molten thermoplastic macromolecular material. It can, for example, be introduced in the form of a gel or solid powder or in the form of a dispersion in water or in an organic dispersant.

The proportion by weight of the phosphate in the composition based on a macromolecular material is preferably less than or equal to 5%.

The phosphates of the invention can be used more particularly in the case where the macromolecular material is a latex.

The latexes are aqueous dispersions of particles of polymers resulting from conventional processes for the emulsion (co)polymerization of polymerizable organic monomers.

These organic monomers can be chosen, for example, from:
a): alkyl (meth)acrylates, the alkyl part of which preferably comprises from 1 to 18 carbon atoms, in particular methyl acrylate, ethyl acrylate, propyl acrylate, n-butyl acrylate, isobutyl acrylate, amyl acrylate, lauryl acrylate, isoamyl acrylate, (2 2-ethylhexyl) acryl, octyl acrylate, methyl methacrylate, chloroethyl methacrylate, butyl methacrylate, 3,3-dimethylbutyl methacrylate, ethyl methacrylate, isobutyl methacrylate, isopropyl methacrylate, phenyl methacrylate, butyl chloroacrylate, methyl chloroacrylate, ethyl chloroacrylate, isopropyl chloroacrylate or cyclohexyl chloroacrylate;
b): α,β-ethylenically unsaturated esters of monocarboxylic acids, the acid part of which is nonpolymerizable and the unsaturated part of which preferably comprises 2 to 14 carbon atoms and the acid part of which comprises from 2 to 12 carbon atoms, in particular vinyl acetate, vinyl propionate, vinyl butyrate, allyl acetate, vinyl versatate (registered trademark for esters of α-branched acids with 9 to 11 carbon atoms), vinyl laurate, vinyl benzoate, vinyl trimethylacetate, vinyl pivalate and vinyl trichloroacetate;
c): esters and hemiesters of α,β-ethylenically unsaturated polycarboxylic acids having from 4 to 24 carbon atoms, in particular dimethyl fumarate, diethyl maleate, ethyl methyl fumarate or 2-ethylhexyl fumarate;
d): vinyl halides, in particular vinyl chloride, vinyl fluoride, vinylidene chloride or vinylidene fluoride;
e): vinylaromatic compounds preferably exhibiting at most 24 carbon atoms and chosen in particular from styrene, α-methylstyrene, 4-methylstyrene, 2-methylstyrene, 3-methylstyrene, 4-methoxystyrene, 2-hydroxymethylstyrene, 4-ethylstyrene, 4-ethoxystyrene, 3,4-dimethylstyrene, 2-chlorostyrene, chlorostyrene, 4-chloro-3-methylstyrene, 4-tertbutylstyrene, 4-dichlorostyrene, 2,6-dichlorostyrene, 2,5-difluorostyrene and 1-vinylnaphthalene;
f): conjugated aliphatic dienes preferably exhibiting from 3 to 12 carbon atoms, in particular 1,3-butadiene, isoprene and 2-chloro-1,3-butadiene;
g): α,β-ethylenically unsaturated nitriles preferably having from 3 to 6 carbon atoms, such as acrylonitrile and methacrylonitrile. Mention may also be made of homopolymer latexes, in particular poly(vinyl acetate) latexes.

It is also possible to use copolymers of some of the abovementioned main monomers with up to 50% by weight of other monomers with an ionic nature, in particular:
an α,β-ethylenically unsaturated carboxylic acid monomer mentioned above including mono- and polycarboxylic acids (acrylic acid, methacrylic acid, maleic acid, itaconic acid, fumaric acid, and the like),
an ethylenic monomer comprising secondary, tertiary or quaternized amine groups (vinylpyridines, diethylaminoethyl methacrylate, and the like),
a sulfonated ethylenic monomer (vinylsulfonate, styrenesulfonate, and the like),
a zwitterionic ethylenic monomer ((sulfopropyl)dimethylaminopropyl acrylate),
or with a nonionic nature, in particular:
amides of unsaturated carboxylic acids (acrylamide, methacrylamide, and the like),
(meth)acrylate esters of polyhydroxypropyl or polyhydroxyethylated alcohols.

Mention may more particularly be made of copolymers of styrene with acrylates and styrene-butadiene copolymers.

The incorporation of the zirconium phosphates of the invention in the compositions based on macromolecular materials makes it possible to improve in particular the barrier properties to gases, in particular to water vapor, of the latter and their mechanical properties, such as the temperature stiffness.

The products of the invention can also be used as thickeners in aqueous or organic media to give viscosity effects, in particular in aggressive media, for example highly acidic media. The gelling of detergent products may be thought of.

Examples will now be given.

In these examples, specific surface values will be presented. These values were determined by two methods.

The first method gives the BET specific surface, determined by nitrogen adsorption in accordance with the ASTM D 3663-78 standard drawn up from the Brunauer-Emmett-Teller method described in the journal “The Journal of the American Chemical Society, 60, 309 (1938)”.

The second method is based on small angle X-ray scattering. The specific surface value obtained makes it possible to characterize the degree of exfoliation of the zirconium phosphates.

This method is based on a property of radiation scattering applied to particle systems. In the case where the objects under consideration are dense and delimited by a clearcut interface, there exists a certain angular region where the scattered intensity obeys “Porod's law” (Porod, G. (1951), Kolloid K., 124, 83-114; Porod, G. (1982) in Small Angle Scattering, O. Glatter & O. Kratky, pp. 17-51, Academic Press, New York). According to this law, the intensity decreases in proportion to the wave vector to the power −4. It is then possible to relate this intensity to the surface area/volume ratio of the objects under consideration.

The application of this law to divided solids makes it possible to measure a specific surface (Spalla O., Lyonnard S., Testard F., J. Appl. Cryst. (2003), 36, 338-347). The thickness of solid effectively traversed by the beam is quantified by the application of the Beer-Lambert law, the coefficient of absorption of the solid phase at the wavelength under consideration being known. This coefficient of absorption is determined by the chemical composition and the density of the solid concerned.

The experimental procedure is as follows:
1) Inserting the dispersion of the exfoliated phosphate into a cell with a well-controlled thickness (1 mm) and a well-controlled leaktightness which is delimited by two windows appropriate for X-ray scattering experiments (Kapton® film).
2) Leaving for a time sufficient to have good measurement statistics in the angular region where Porod's law is observable.
3) Leaving for an equivalent time with regard to a second cell composed solely of the dispersion medium (continuous phase) and delimited by two windows identical to those used for the dispersion.
4) Measuring the transmissions of the dispersion and of the continuous phase.

The processing of the data breaks down as follows:
a) Determination of the intensity curves: wave vector with regard to the dispersion and with regard to the continuous phase, taking into account the duration of exposure and the level of the incident beam.
b) Determination of the subtracted intensity: intensity of the dispersion minus that of the continuous phase.
c) Determination of the thickness of solid on the basis of the transmission, on the one hand, and of the coefficient of absorption, on the other hand (the latter depending on the incident wavelength, on the chemical composition and on the density of the solid phase).
d) Calculation of the intensity scattered by the solid in absolute units: per centimeter of sample (unit cm⁻¹)
e) Plot of the Kratky-Porod diagram: intensity x (wave vector to the power 4) as a function of the wave vector.
f) Determination of the level of the horizontal plateau.
g) Calculation of the specific surface from the level of this plateau and from the density of the solid.

Reference may be made to the abovementioned Spalla et al. publication, which fully describes all the stages of the procedure. It should be noted that, if the thickness of the cells cannot be controlled, a calculation can be carried out on the basis of the coefficients of absorption of the solid and of the continuous phase. The determination of the thickness of solid has to be validated by a comparison with the value which can be calculated on the basis of the mass fraction of the dispersion and of the density of the solid.

### EXAMPLE 1

This example relates to the preparation of a crystalline zirconium phosphate which can be used as starting material in the preparation of a zirconium phosphate (ZrP) according to the invention.

The following reactants are used:
hydrochloric acid (Prolabo, 36%, d 1.19)
phosphoric acid (Prolabo, 85%, d=1.695)
deionized water
zirconium oxychloride (in the powder form) comprising 32.8% of ZrO₂.
   First Stage: Precipitation

An aqueous zirconium oxychloride solution comprising 2.1 mol/l of ZrO₂ is prepared beforehand.

The following solutions are added at ambient temperature to a stirred 1 liter reactor:
hydrochloric acid: 50 ml
phosphoric acid: 50 ml
deionized water: 150 ml

After stirring the mixture, 140 ml of the 2.1M aqueous zirconium oxychloride solution are added continuously with a flow rate of 5.7 ml/min.

Stirring is maintained for 1 hour after the end of the addition of the zirconium oxychloride solution.

Second Stage: Washing

After removing the aqueous mother liquors, the precipitate is washed with 1200 ml of 20 g/l H₃PO₄ and with 2 l of deionized water, until a conductivity of less than 3 mS (supernatant) is achieved. A cake of the precipitate based on zirconium phosphate is obtained.

Third Stage: Crystallization

The cake is dispersed in 1 liter of aqueous phosphoric acid solution such that the final concentration of acid is 8.8M, the dispersion thus obtained is transferred into a 2 liter reactor and is then heated to 115° C. This temperature is maintained for 5 hours.

The dispersion obtained is washed until a conductivity of at most 1 mS (supernatant) is achieved. The cake resulting from the final centrifuging is redispersed so as to obtain a solids content in the region of 20%. The pH of the dispersion is 2.5.

A dispersion of a crystalline compound based on zirconium phosphate is obtained, the characteristics of which are as follows:

Analysis using a Transmission Electron Microscope (TEM) demonstrates particles with a size of between 150 and 200 nm and with a mean size of 140 nm.

The X-ray scattering analysis demonstrates that the crystalline phase Zr(HPO₄)₂.1H₂O has been obtained.

The intersheet distance is 7.65 angstroms.

The solids content is 20% (by weight).

BET specific surface of the dry product: 20 m²/g.

### EXAMPLE 2

This example relates to the preparation of a sodium zirconium phosphate and a zirconium phosphate with an exfoliated structure according to the invention.

80 g of the dispersion obtained in example 1, i.e. 0.05 mol of α-ZrP, are withdrawn and are diluted to 400 ml. The small angle X-ray scattering method gives a specific surface of 50 m²/g. 0.1 mol of sodium hydroxide (20 ml of 5N NaOH), i.e. a Na/P ratio of 1, is added with stirring, which results in a pH value of 8. A sodium zirconium phosphate, the precursor of a zirconium phosphate with an exfoliated structure, is thus obtained. A zirconium phosphate with an exfoliated structure is obtained in the following way.

The mixture is left stirring for one hour and is then diluted to 1.6 l with water. Hydrochloric acid is subsequently added until a pH of 2 is achieved. A gel is obtained.

This gel is subsequently washed. For this, it is centrifuged and resuspended in 1600 ml of water, this operation being repeated a further two times, to give a gel according to the invention exhibiting a pH of between 3 and 4 and a water content of 95%.

Analysis by cryogenic TEM shows that the gel is composed of sheets distributed in a disorganized way.

X-ray analysis demonstrates an amorphous structure.

The conductivity of the gel is less than 2 mS.

The small angle X-ray scattering method gives a specific surface of 500 m²/g.

The carbon content with regard to the dried product, expressed as indicated above, is 300 ppm.

The ³¹P solid-state NMR performed on a powder formed of the dried product demonstrates chemical shifts at −19 ppm and −23 ppm.

### EXAMPLE 3

This example relates to the preparation of a zirconium phosphate of the second precursor type and of a zirconium phosphate with an exfoliated structure according to the invention.

100 g of the zirconium phosphate in the form of a 32.9% aqueous dispersion as obtained in example 1 are diluted with 300 g of deionized water. 45.8 ml (54 g) of 5N sodium hydroxide solution, i.e. a Na/P ratio of 1, are added. The mixture is left stirring for 30 min. The pH is then in the region of 8.

The pH is subsequently brought down to 1.5 using a 5 moles per liter phosphoric acid solution. After stirring for 10 min, the mixture is centrifuged and the clear supernatant is discarded. The centrifuging residue is recovered (93.4 g). A zirconium phosphate, the second precursor according to the invention, is thus obtained.

The ³¹P solid-state NMR performed on a powder formed of the product demonstrates chemical shifts at −19 ppm, −21 ppm and −23 ppm.

The X-ray scattering gives a diffraction spectrum with peaks at 10.66 and 5.32 which can be assigned to Zr(HPO₄)₂.8H₂O and at 7.65 which can be assigned to α-zirconium phosphate.

The preceding precursor (93.4 g) is diluted in water (addition of 1080 g of deionized water). A gelling characteristic of the exfoliation is observed in 25 minutes.

The carbon content, expressed as indicated above, is 300 ppm.

### EXAMPLE 4

200 g of the gel obtained in example 2, i.e. 10 g on a dry basis, are introduced into a stirred reactor and diluted to 1 liter. The pH is adjusted to 9.5 by addition of 5N sodium hydroxide solution. The temperature of the reaction medium is raised to 90° C. The simultaneous introduction is carried out of an alkali metal silicate solution (SiO₂ 235 g/l, SiO₂/Na₂O ratio by weight 3.57), diluted to 50 g/l, with a flow rate of 2.8 ml/min, and of a 2N sulfuric acid solution, to keep the pH constant (9.5). After introducing the reactants, the temperature of the reactor is maintained at 90° C. for 2 hours.

After cooling, the product is centrifuged and then washed with 1600 ml of demineralized water. Finally, the product is dried by atomization. It exhibits a level of silica of 48.4% and a specific surface of 118 m²/g (BET specific surface).

The examples which follow illustrate the embodiment of the invention in which the phosphate comprises an intercalation compound.

### EXAMPLE 5

This example relates to the intercalation of 2,2′-azobis(2-methylpropionamidine) dihydrochloride.

250 g of the gel obtained in example 2, i.e., 12.5 g on a dry basis, are dispersed in 1 liter of demineralized water and then 10 g of 2,2′-azobis(2-methylpropionamidine) dihydrochloride, dissolved beforehand in 200 ml of demineralized water, are added. The mixture is stirred at 20° C. for 3 hours, is centrifuged and the product is dried at 20° C.

The intersheet distance, measured by X-ray scattering, is 13.5 Å.

### EXAMPLE 6

This example relates to the intercalation of aminocaproic acid.

580 g of the gel obtained in example 2, i.e., 29 g on a dry basis, are dispersed in 1.6 liters of demineralized water and then 29 g of aminocaproic acid, dissolved beforehand in 200 ml of demineralized water, are added. The mixture is concentrated to 200 ml by evaporation under a flow of air at 20° C. and then drying is carried out in an oven at 110° C. for 15 hours.

The intersheet distance, measured by X-ray scattering, is 25.9 Å.

### EXAMPLE 7

This example relates to the intercalation of caprolactam.

400 g of the gel obtained in example 2, i.e., 20 g on a dry basis, are dispersed in 1.2 liters of demineralized water and then 20 g of caprolactam, dissolved beforehand in 200 ml of demineralized water, are added. The mixture is concentrated to 200 ml by evaporation under a flow of air at 20° C. and then drying is carried out in an oven at 50° C. for 15 hours.

The intersheet distance, measured by X-ray scattering, is 14.9 Å.

### EXAMPLE 8

This example relates to the intercalation of aminomethylphosphonic acid (AMPA).

300 g of the gel obtained in example 2, i.e., 15 g on a dry basis, are dispersed in 1 liter of demineralized water and then 10 g of AMPA, dissolved beforehand in 200 ml of demineralized water, are added. The suspension is concentrated to 200 ml by heating to boiling point. The mixture is centrifuged and the product is washed with 1.2 liters of demineralized water; the product is dried at 50° C. for 15 hours.

The intersheet distance, measured by X-ray scattering, is 15.5 Å.

### EXAMPLE 9

This example relates to the intercalation of (3-aminopropyl)triethoxysilane (AMEO).

300 g of the gel obtained in example 2, i.e., 15 g on a dry basis, are dispersed in 1 liter of demineralized water and then 22 g of AMEO are added. The mixture is stirred at 20° C. for 15 hours. The mixture is centrifuged and the product is washed with 1.2 liters of demineralized water; the product is dried at 50° C. for 15 hours.

The intersheet distance, measured by X-ray scattering, is 19.5 Å.

### EXAMPLE 10

This example relates to the use, in a latex, of a product according to the invention.

The starting material is a polystyrene-butadiene latex, Rhoximat SB 500, in an amount of 100 g with a solids content of 49.4%.

1.4 g of the centrifuging residue comprising the second precursor of example 3 are added to this latex. The mixture is stirred at 25° C. for 10 min.

A film with a thickness of 100 microns is formed on a sheet of glass and is dried at ambient temperature.

The film thus obtained is transparent. It exhibits to the eye the same transparency as a film obtained from the same latex but without phosphate. The observations made by TEM ultramicrotomy demonstrate the exfoliation of the zirconium phosphate.

1-27. (canceled)

28. A zirconium phosphate with an exfoliated structure, provided in the form of a gel, whose content of organic compounds is of at most 1000 ppm, optionally at most 500 ppm.

29. A zirconium phosphate with an exfoliated structure, in the form of a gel devoid of organic compounds chemically bonded to the phosphate.

30. The phosphate as claimed in claim 29, having a content of organic compound of at most 1000 ppm, optionally of at most 500 ppm.

31. The phosphate as claimed in claim 28, composed of particles exhibiting a form factor of between 100 and 5000.

32. The phosphate as claimed in claim 28, wherein the gel exhibits a pH of at most 4, optionally at most 2.

33. The phosphate as claimed in claim 28, presenting, by solid-state NMR analysis, shifts at −19 ppm and at least one other shift of between −20 ppm and −23 ppm.

34. A zirconium phosphate with an exfoliated structure, provided in the form of a gel in an organic solvent and obtained from a phosphate as claimed in claim 28.

35. A zirconium phosphate with an exfoliated structure, comprising an intercalation compound between its constituent sheets of particles and having been obtained from a phosphate as claimed in claim 28.

36. The phosphate as claimed in claim 28, further comprising silica, alumina or titanium oxide.

37. A sodium zirconium phosphate, wherein it exhibits a Na/P ratio of greater than 0.5, optionally at least equal to 0.8.

38. The phosphate as claimed in claim 37, providing, by acidification, a zirconium phosphate with an exfoliated structure in the form of a gel, whose content of organic compounds is of at most 1000 ppm, optionally at most 500 ppm.

39. The phosphate as claimed in claim 37, providing, by acidification, a zirconium phosphate with an exfoliated structure in the form of a gel, devoid of organic compounds chemically bonded to the phosphate.

40. The phosphate as claimed in claim 37 provided in the form of a dispersion with a pH of at least 7, optionally of at least 9.

41. A zirconium phosphate, presenting, by solid-state NMR analysis, shifts at −19 ppm and at least one other shift of between −20 ppm and −23 ppm and an X-ray diffraction diagram with peaks at 10.66, 5.32 and 7.65.

42. A process for the preparation of the zirconium phosphate as claimed in claim 28, comprising the steps of:
(a) forming an aqueous dispersion of a crystalline zirconium phosphate;
(b) adding a sodium compound to said dispersion in an amount such that the Na/P ratio is greater than 0.5, optionally at least equal to 0.8; and
(c) subsequently added an acid, whereby either a gel or a solid compound is obtained, which solid compound is re-suspended in water and gives a gel.

43. The process according to claim 42, wherein the crystalline zirconium phosphate is prepared by precipitating, in an acidic medium, a zirconium phosphate from phosphoric acid and from a zirconium compound, the zirconium being in the IV oxidation state, and by then optionally subjecting the product obtained to a heat treatment.

44. The process as claimed in claim 42, wherein use is made, in step (c), the acid is hydrochloric acid, sulfuric acid, nitric acid or phosphoric acid.

45. The process as claimed in claim 42, wherein the acid is being added in stage (c) until a pH of at most 3 is obtained.

46. The process as claimed in claim 42, wherein the gel obtained in stage (c) is washed until a pH of at most 4 is obtained.

47. A process for the preparation of a zirconium phosphate further comprising silica, alumina or titanium oxide, comprising the step of bringing into contact the zirconium phosphate as claimed in claim 28 and a precursor of said oxide and, then, precipitating the oxide.

48. A process for the preparation of the zirconium phosphate as claimed in claim 34, comprising the step of mixing an aqueous gel of the zirconium phosphate with an exfoliated structure, provided in the form of a gel, whose content of organic compounds is of at most 1000 ppm, with the organic solvent and then the mixture is heated to remove the water.

48. A process for the preparation of the zirconium phosphate as claimed in claim 35, comprising the step of mixing an aqueous gel of the zirconium phosphate with an exfoliated structure, provided in the form of a gel, whose content of organic compounds is of at most 1000 ppm, with the intercalation compound or with a precursor of the latter.

49. A process for the preparation of the zirconium phosphate as claimed in claim 41, comprising the steps of:
(a) forming an aqueous dispersion of a crystalline zirconium phosphate;
(b) adding a sodium compound to said dispersion in an amount such that the Na/P ratio is greater than 0.5, optionally at least equal to 0.8; and
(c) subsequently adding an acid, whereby the zirconium phosphate is obtained in the solid form in the reaction medium.

50. A process for the preparation of the sodium zirconium phosphate as claimed in claim 37, comprising the steps of:
(a) forming an aqueous dispersion of a crystalline zirconium phosphate; and
(b) adding a sodium compound to said dispersion in an amount such that the Na/P ratio is greater than 0.5, optionally at least equal to 0.8.
